(19) United States
(12) Patent Application Publication
(10) Pub. No.: US 2001/0044730 A1
(43) Pub. Date: Nov. 22, 2001

(54) Method and system for using a communications network in the selection and delivery of pharmaceutical formulation information, training and products

(76) Inventor: Joe D'Silva, North Wales, PA (US)

Correspondence Address: Connolly Bove Lodge & Hutz LLP, 1220 Market Street, P.O. Box 2207, Wilmington, DE, 19899, US

(21) Appl. No.: 09/847,990

(22) Filed: May 3, 2001

Related U.S. Application Data
(60) Provisional application No. 60/201,630, filed on May 3, 2000.

(51) Int. Cl. G06F 17/60

(52) U.S. Cl. 705/3

(57) ABSTRACT

The present invention provides a computer-implemented system and method for providing information and ordering products for preparing liquid pharmaceutical formulations on demand from tablets and capsules.

This application is a continuation-in-part of provisional application U.S. Serial No. 60/201,630, filed May 3, 2000, now abandoned, which is hereby incorporated by reference herein in its entirety.

### FIELD OF THE INVENTION

The present invention relates to a computerized communication system for providing information and for ordering products for formulating liquid and semi-solid pharmaceutical compositions (collectively “liquid dosage formulations”) on demand from one or more solid dosage forms of a medicinal compound. Preferably, the computerized communication system uses the Internet to communicate information.

### BACKGROUND OF THE INVENTION

The present invention is directed to computerized communications systems that provide information interactively and securely to assist in the proper preparation of extemporaneously compounded liquid dosage formulations, and also that provide for training and for ordering products and services relating to pharmaceutical products and their administration.

The Internet comprises a vast number of computers and computer networks that are interconnected through communication links. The Internet involves a server computer system such as a Web server or Web site that sends graphical Web pages of information to a remote client computer system. The remote client computer system then displays the Web pages. Each resource (e.g., computer or Web page) of the world wide web is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it displays the Web page using a browser. A browser is a special-purpose application program for displaying Web pages. Most Web pages are formatted in accordance with a computer program written in a language known as HTML (hypertext markup language). A Web browser parses the HTML script to display the text in accordance with a specified format.

Many Web servers have been developed through which vendors can advertise and sell product, and through which organizations can provide information. The invention uses computerized communications systems that involve the use of an interactive communication network such as the Internet to provide information and training on formulating liquid pharmaceutical dosages on demand from solid dosage forms and for ordering products for use in such formulations in an interactive fashion.

There exists a great unmet need for palatable liquid dosage formulations to treat patients for whom the traditional solid tablet or capsule is not a feasible dosage form. Some patients are unable to ingest tablets and capsules in a single and smooth swallowing motion, or lack desire to ingest such dosage forms. Also, some tablets and capsules have an unpleasant taste or a large or unpleasant size. Patients who encounter such problems include the elderly, particularly those in nursing homes, pediatric patients, and patients who have encountered severe trauma due to surgery or involvement in accidents. Also, animals often will not or cannot swallow tablets or capsules. In the text that follows, the term “patient” refers to humans and animals.

In such situations, health care providers wish to have available alternative dosage forms, especially liquids that are easy to swallow. In many cases, however, a liquid dosage form is not commercially available or, in some instances, the commercially available liquid dosage product is not suitable for the patient. In such circumstances, health care providers are forced to improvise and prepare liquid products in an extemporaneous fashion. Common approaches include grinding tablets in a mortar and pestle and adding the resultant powder to an excipient such as applesauce or a suitable fruit juice. In the case of capsules, the shells are separated and the enclosed powder added to a suitable excipient. The resultant mixture is then administered to the patient. Although this accomplishes the objective of providing the medicinal compound to the patient, the process does not guarantee delivery of the total dosage to the patient nor that the compound will be stable in the extemporaneously compounded product.

For example, medicinal compounds can decompose, Decomposition often accelerates when the compound is in a liquid. The uncontrolled decomposition of the medicinal compound in an extemporaneously prepared liquid formulation could reduce the effective administered dose. In addition, the patient could be exposed to undesirable decomposition products.

Another problem with extemporaneously preparing liquid formulations is that patients still resist taking the full dosage amount because of the unpleasant taste of the composition. If these disadvantages are not resolved, high degrees of patient compliance cannot be assured.

The system of the invention provides an easy and convenient solution to make available information and products to aid in the preparation of extemporaneously compounded liquid formulations from tablets, capsules and other solid or gel pharmaceutical dosage forms (collectively “solid dosage forms”). The invention described herein employs computerized communication systems to provide formulation information interactively to health care providers for assistance in the selection of appropriate excipients and in the proper extemporaneous compounding of palatable liquid dosage formulations from solid dosage forms. Also, under the system of the invention, the purchase of products which meet the needs of the health care provider or patient is possible.

The system of the present invention is advantageous because it solves some long-standing problems relating to preparing liquid pharmaceutical preparations on an extemporaneous basis. Medicinal compounds, in certain conditions, may be unstable and decompose. Administration of decomposition products to a patient could lead to unwanted adverse events. Therefore, the preparation of extemporaneously compounded liquid dosage formulations from commercially available solid dosage forms is preferably aided by access to two important resources: a) appropriate equipment and materials and b) formulation information. “Formulation information” includes information on chemical stability of various medicinal compounds in various diluents and with various excipients, palatability information, viscosity information, and methods of formulation. The combination of these resources helps ensure that liquid dosage formulations administered to patients are both appropriate and prepared to maintain the integrity of the medicinal compound.

### BRIEF SUMMARY OF THE INVENTION

The invention concerns a computerized communication system for communication of information about a liquid dosage formulation comprising a medicinal compound and delivery of the information between a health care provider organization and a central source of such information comprising:

a) at least one data input means available to the health care provider organization for inputting information about needs of one or more patients for the liquid dosage formulation,

b) program means executable by at least one data processing means for processing said patient information into a format for transmission thereof over an interactive communication network, and

c) a server system for containing information about the liquid dosage formulation and for transmitting said information to the health care provider organization over the interactive communication network in response to receipt of patient information from the health care provider organization. communication network in response to receipt of patient information from the health care provider organization.

### DETAILED DESCRIPTION OF INVENTION

According to one embodiment of the system of the invention, each health care provider organization obtains a unique identification code. Health care provider organization includes hospitals, nursing homes, clinics, hospices, health maintenance organizations, doctors, pharmacies, veterinarians, veterinary clinics, and other such health care service organizations. The unique identification code provides a first level of client identification to a designated server system. Preferably, the unique identification code is obtained by making a request via the mail, telephone or facsimile. This allows for the process to be initiated in a completely confidential manner. The unique identification code may also be obtained through communications over an interactive communication network, such as the Internet.

A request for liquid formulation information is placed by a health care provider at a client system and then transmitted over an interactive communication network such as the Internet to a designated server system. The client system provides the unique identification code to the designated server system. Upon connecting to the designated server system for the first time, each qualified person within the health care provider organization will obtain a unique sub-identification code from the server system. This sub-identification code is a combination of the unique identification code assigned to the health care provider organization and a new identifier uniquely assigned for that individual qualified person. The person will provide to the server system electronic and postal addresses and telephone and facsimile numbers. Thus, individuals have ownership of a unique identification number linking them to a database within the designated server system. The unique sub-identification code provides an individual with a password-protected access to the server system. Subsequent contacts with the server for the individual will solely require the providing of the unique sub-identification code to initiate further transactions.

The request for liquid formulation information is transmitted to the designated server system using an interactive communications network. “Interactive communications network” as used herein includes an Internet, intranet, extranet, LAN, wide area network (WAN), metropolitan area network (MAN), telephone network such as the public switched telepohone network (PSTN), or any similar network.

The server system receives information from the individual at the health care provider organization including his or her unique sub-identification code, the name of the medicinal compound to be administered to a patient, the prescribed dosage, and any special needs of the patient to whom the medicinal compound will be administered. The request may also include information about the patient, such as name, age, weight, physical condition, and name of the other medications taken by the patient. The server system processes the information and reports the following data: a) the formulation or formulations that would best serve the patient's needs; b) products useful in creating or administering a formulation; and c) the formulation information that is required to understand the scientific principles involved in the use of the suggested products and suggested formulations.

The server system assigns a unique request identifier to the request from the client system and associates the assigned request identifier with the information provided by the server, the request submitted by the client system, and any product requests received from the individual requester and/or the health care provider organization relating to the particular request. The server system then returns to the client system and the individual requester the assigned request identifier and the requested formulation information, preferably in an HTML document. The HTML document displays designated buttons that allow the health care provider to access procedures for ordering the necessary products for a patient and for accessing formulation information explaining the scientific principles governing the proper preparation and administration of the formulation. The individual is also provided with contact information that can be employed to gain answers to any questions that may arise regarding the preparation and administration of the formulation. If appropriate, the individual is alerted to the fact that there are other qualified individuals within his or her particular health care provider organization who have relevant experience with the products being ordered or the formulations being recommended. The individual is encouraged to discuss the preparation of the formulation with these individuals. In particular, within large health care provider organizations such interactions will serve as an important source of training. Personal interactions will serve to reinforce the information provided to the individual by the server system. The server also inputs into a server system database information on the request, such as the particular health care provider organization and the individual in the provider organization who placed the request.

Based on the unique sub-identification code system, the server determines if the individual requestor has previously accessed the system. The server determines whether the requestor has previously accessed this formulation information and whether he or she has received training related to the use of the information. In one embodiment, if the individual requester has not previously reviewed the appropriate formulation information, the system provides a prompt, such as a designated button, which when responded to provides access to relevant information on-line. The system prompts the individual requester to review the information. The system therefore ensures that in addition to allowing for the purchase of the desired products, the health care provider is prompted to access and gain knowledge of the scientific principles that govern the proper use of the products. The server system may also evaluate the previous interactions of all members of the particular health care provider organization with the server, any special requirements of the particular health care provider organization, and the medicinal compound that is being considered for administration to the patient. Based on this evaluation, the server system may prompt the requester to interact with other members of the organization who have had previous experience with the use of products similar to those being considered by the requester. Such interactions provide reinforcement to the training provided by the sever system via the HTML document. The system will serve to enhance interactions and training regarding the products among the personnel in the health care provider organization. Such evaluation helps ensure that the patient receives the optimum dosage formulation and that the health care provider is given access to the appropriate type and amount of information and training that will allow for the proper preparation of the liquid dosage formulations.

The ordering of products is accomplished by using any one of the well-known methods in electronic commerce, such as the “shopping cart” model or the “one-click” model described in U.S. Pat. No. 5,960,411, “Method and system for placing a purchase order via a communications network”, which is incorporated by reference herein in its entirety. Other means for ordering include providing telephone, mail, or fax information to whom one could address requests for products. Ordering is completed by providing any necessary shipping, billing and selection information over the Internet, or through electronic mail systems, facsimile transmission, telephone, mail, or courier systems. Methods for maintaining the secure transmission of confidential customer billing information, such as the customer's credit card number, can be employed. For example, the methods disclosed in U.S. Pat. No. 5,727,163, “Secure method for communicating credit card data when placing an order on a non-secure network”, which is incorporated by reference herein in its entirety, may be used. Preferably, products specific to preparing liquid dosage formulations will be provided, such as excipients, excipient mixtures, shakers for formulations, mixing and dosing cups, oral dosing syringes, etc. The excipients may be sold as prepackaged combinations in the form of a compressed tablet, powder, paste, gel, sachet, or liquid. Preferably, the server system identifies specific products from a catalog that are useful in preparing the formulation selected by the server in response to the individual requester's submission and provides this selection to the individual requester in a way that allows for ordering one or more of the products. Services may also be ordered.

The server system is a programmable data storage and processing means for containing and transmitting information over an interactive communication network. Preferably, it includes a server engine, a sub-identification code/individual customer table, a unique identification code/health care provider organization customer table, various Web pages, a customer database, a formulation information database, a product and service order database, and an inventory database. The server engine receives HTTP requests to access Web pages identified by URLs and provides the Web pages to various client systems. The sub-identification code/individual customer table contains a mapping from each sub-identification code to the individual customer. The unique identification code/health care provider organization customer table contains a mapping from each unique identification code to the individual health care provider organization. The customer database contains data on the products and information accessed or purchased by various health care provider organizations and their employees. The customer database also contains a unique request identifier/patient information table and a table associating each request placed by an individual to the server system with the response(s) provided (“Healthcare Provider Experience Table”). The formulation information database contains up-to-date records on the stability, palatability, and viscosity of various medicinal compounds in liquid dosage formulations compounded extemporaneously employing components available via the Web site and commercially available tablets and capsules.

The server system may comprise any combination of hardware or software that can interact with the client system and provide the requisite data storage and processing according to the system of the invention. Preferably, the server system includes a bus interconnecting a processor, a read-only memory (ROM), a main memory, a storage device, an input device, an output device, and a communication interface. Bus is a network topology or circuit arrangement in which all devices are attached to a line directly and all signals pass through each of the devices. Each device has a unique identity and can recognize those signals intended for it. ROM includes a static memory that stores instructions and date used by processor.

Computer storage is the holding of data in an electromagnetic form for access by a computer processor. Main memory, which may be a RAM or another type of dynamic memory, makes up the primary storage of the server system. Secondary storage may comprise storage devices, such as hard disks, tapes, diskettes, Zip drives, RAID systems, holographic storage, optical storage, CD-ROMs, magnetic tapes, and other external devices and their corresponding drives.

Output device may comprise a display, a printer, a sound device (e.g. a speaker, etc.), or other device providing output. Communication interface may include network connections, modems, or other devices used for communications with other computer systems or devices.

The client system comprises a browser and a sub-identification code for each registered user at the client health care provider organization. The sub-identification code preferably is stored in one or more files on the client system, referred to as a cookie. Preferably, each time a new user at the client health care provider organization first accesses the system of the invention, the server system assigns electronically a sub-identification code for that user. The sub-identification code may also be assigned non-electronically, such as by telephone or fax communication. After assignment of the sub-identification code, the client system includes the individual user's sub-identification code with all messages sent to the server system by that individual so that the server can identify the source of the message. The server and client systems interact by exchanging information over an interactive communications network, which may include transmission over the Internet.

A client system may comprise any combination of hardware or software that can interact with the server system. The client system preferably comprises at least one data input means and at least one program means executable by at least one data processing means for processing patient or medicament information for transmission over the interactive communication network. Data input means include a keyboard, mouse, pointing device, sound device (e.g. a microphone, etc.), biometric device, or any other device providing input for data into the client system. Program means executable by at least one data processing means includes any computerized system capable of processing data from the input means into a format for transmission over an interactive communication network, such as a computer having a processor, at least one memory, and a communications interface. The processor has the logic circuitry to respond to and process the basic instructions that are received from the input means.

In one preferred embodiment, the system of the present invention employs the Internet to ensure that information for ordering products for formulating liquid dosages and the relevant formulation information are available at a single location and in an interlinked fashion. According to the system of the invention, the informational needs of health care providers are evaluated based on the products that are being requested, previous orders from the healthcare provider organization and prior access of the individual and of others within the healthcare provider organization to relevant information from the server. The system helps the health care provider offer high quality care. The quality is based on the assurance that all health care providers are given access to relevant information. This access is provided in an active and prominent fashion via a well-marked button on the HTML page that is returned to the client. The individual requester at the health care provider organization is actively encouraged to review and understand the information prior to placing orders for formulation products and to discuss the scientific principles concerning the formulation with other members of the organization who have previous experience in relevant formulations and formulation products. The system therefore allows appropriate formulation products to be selected easily and provides information so that the health care provider is well aware of the scientific principles behind their usage and how to use them properly. The system aids in a safe and efficacious liquid dosage formulation being administered to the patient.

The system described herein is designed for efficiency, constant and active improvement, and security. Health care providers work under tight time lines. However, due to the very nature of their jobs, they have to pay close attention to the details of the products that are administered to their patients. The system described herein assists in accomplishing these goals.

a) Efficiency: The interactions of the server system and client system serve to develop a database within the server system storing data unique to each individual healthcare provider organization, its employees and patients. By use of this data, the system ensures that the healthcare provider organization employees do not have to repeatedly review a large product database. Rather, the system selects and presents information that is relevant to the unique requirements of the health care provider organization.

b) Constant and Active Improvement: The system also ensures that relevant information updates are provided by providing updates using e-mail, when necessary, to health care provider employees enrolled in the database. Proper acknowledgment of the receipt and review of these updates is included in the server's database. The updates serve to continuously enhance the quality of the information employed by the health care providers when selecting and placing orders for products for their patients. The updates also serve to enhance the efficiency of the system. The health care provider organization employees can review the information provided in the updates at their leisure. The system serves to proactively prompt interactions among the personnel of a health care provider organization with regard to the technical issues associated with the preparation and use of formulation products. This secondary source of training serves to reinforce the information provided by the system through the sever. Training is especially important for those individuals using the formulation products for the first time.

c) Security: Lastly, the use of a unique sub-identification code for each individual health care provider employee enhances the security of the transactions and the data being transmitted between the client system and the server system. Information being transmitted over the Internet passes through various intermediate computer systems before reaching its final destination. The information is generally encrypted to enhance the security of the data in the event dishonest persons intercept it. Encryption of information does enhance its security by making it difficult for the intercepted information to be decrypted and read by the interceptor. However, as with many technical systems encryption can on occasion fail to accomplish its intended goal. One of the techniques to enhance the security of the system is to reduce the amount of information that has to be transmitted between the client system and the server. A direct and efficient manner in which to accomplish this goal is to employ the unique identification codes described above. Once the health-care provider supplies the necessary data, it is maintained in a completely secure fashion by the server. Consequently, during future transactions, the data is accessed by the server system locally without having to be transmitted over the Internet again from the client system. In this way, confidential information such as the identity of the person within the health care provider organization making the request, the type of medication used, dosage levels and patient identification can be maintained confidential. This reduction in the transmission of data will have a direct and beneficial effect on making the data unavailable for interception, decryption, and misuse.

Although the present invention has been described in terms of certain embodiments, it is not intended that the invention be limited to those embodiments. Modifications within the spirit of the invention will be apparent to those of skill in the art. For example, the system of the invention may be used directly by patients or their home care-givers in addition to use by health care provider organizations. Also, the method and system of the invention may be used by pet owners or farm animal owners desiring to administer medications to their animals.

I claim:

1. A computerized communication system for communication of information about a liquid dosage formulation comprising a medicinal compound and delivery of the information between a health care provider organization and a central source of such information comprising:
a) at least one data input means available to the health care provider organization for inputting information about needs of one or more patients for the liquid dosage formulation,
b) program means executable by at least one data processing means for processing said patient information into a format for transmission thereof over an interactive communication network,
c) a server system for containing information about the liquid dosage formulation and for transmitting said information to the health care provider organization over the interactive communication network in response to receipt of patient information from the health care provider organization.

2. The computerized communication system of claim 1 wherein a unique identification code is associated with each health care provider organization in its transmission of information to the server system.

3. The computerized communication system of claim 2 wherein a unique individual sub-identification code is associated with each person at the health care provider organization who accesses the computerized communication system.

4. The computerized communication system of claim 3 wherein a unique request identifier is associated with each receipt of patient information processed by the server system.

5. The computerized communication system of claim 4 wherein the server system further comprises a table associating unique individual sub-identification codes with unique request identifiers.

6. The computerized communication system of claim 4 wherein the server system, after each receipt of patient information from the program means executable by at least one data processing means, associates the unique individual sub-identification code of the person associated with the health care provider organization sending the patient information with the unique request identifier to form a Health Care Provider Experience Table.

7. The computerized system of claim 6 wherein after receipt of patient information and a unique individual sub-identification code, the server system accesses the Health Care Provider Experience Table before transmitting information to the health care provider organization.

8. The computerized communication system of claim 1 wherein the information transmitted to the health care provider organization by the server system is selected from the group consisting of formulation information, information about liquid dosage formulation products, information about sourcing liquid dosage formulation products, information about ordering liquid dosage formulation products, contact information that can be employed to access information about liquid dosage formulations, and the identity of others within the health care provider organization who have made similar requests for information.

9. The computerized communication system of claim 2 wherein the interactive communication network is the Internet.
